(19) United States
(12) Patent Application Publication
(10) Pub. No.: US 2012/0275108 A1
(43) Pub. Date: Nov. 1, 2012

(54) MACHINE FOR THE ELECTRICAL AND GRAPHIC CUSTOMISATION OF PORTABLE ELECTRONIC OBJECTS

(75) Inventor: Herve Mongin, Donnery (FR)

(73) Assignee: Simon ORMEROD, LA CIOTAT (FR)

(21) Appl. No.: 13/513,359

(22) PCT Filed: Dec. 1, 2010
(86) PCT No.: PCT/FR2010/052590

§ 371 Date: Jul. 23, 2012

(30) Foreign Application Priority Data
Dec. 3, 2009 (FR) 09/05827

(51) Int. Cl. G06F 1/16

(52) U.S. Cl. 361/679.41

(57) ABSTRACT

The invention relates to a machine for the electrical and graphic customisation of portable electronic objects, comprising: a loading station; a plurality of treatment stations including at least one laser- or inkjet-marking station and/or an inspection station and/or a label application station; a rejection station; and a customised-object-unloading station. The invention is characterised in that a transfer device comprises a plurality of mobile components, arranged along a closed-loop path, each mobile component being moved along the path and being solidly connected to an encoding head linked to a programming card that is moved by the mobile component. The encoding head is moved successively along the path from a loading station to at least one treatment station, simultaneously performing the electronic customisation of the component, and then either to the outlet or to a rejection station.

The present invention relates to a machine for the electrical and graphic customisation of portable electronic objects.

The present invention relates to an electrical customisation system of communicating electronic objects. These can be smart cards, USB drives or objects which need programming of a component embedded in this object.

Electrical customisation consists of programming the component embedded in the object, either by making electrical contact between the object to be programmed and the programming system, or by using contactless communication.

A portable object means any object including an electronic component provided with at least one microprocessor and at least one programmable non-volatile memory whereof some zones are protected from external access (writing or reading). As this component is inserted in a casing or in a support which itself can be customised graphically by security elements such as, for example, an identity photo of the bearer of the object, data representing the bearer of the object, a barcode, a matrix code, embossing of alphanumeric data, etching of fingerprints, advertising, etc. This graphic customisation must generally be in correlation with the binary data of electronic customisation written into the memory of the component located in the portable object.

Customisation machines known from the prior art comprised a plurality of stations, the first station enabling electrical customisation. The portable objects exiting from this customisation were transported on another station for printing a photo or for laser etching, a third station allowing embossing etc. These machines generally comprised as many stations as electronic or graphic customisation elements to be introduced to/or in the object. The portable objects were transported by transport means successively from one station to the other to then be unloaded at the end of the machine when all customisation operations were completed. These transfer and loading/unloading operations at each station were a possible source of objects falling, poor placement of these objects and consequently disruption of the operation of the resulting assembly. These various handling operations could result in a batch of customised objects not being in the order provided initially by the computer system since some objects fell or were rejected as a result of detection of a defect, and the order of the objects does not exactly follow the order of customisation data files of the computer system which administers all the stations constituting the machine.

An aim of the present machine is to eliminate one or more of the disadvantages specified hereinabove.

This first aim is attained by the electrical and graphic customisation machine of portable electronic objects comprising a loading station, a plurality of processing stations, including at least one laser jet or inkjet marking station and/or an inspection station and/or a label-application station, a rejection station and an unloading station of customised objects, characterised in that a transfer device comprises at least one mobile component, according to a closed-loop path, each mobile component being moved along according to the path and connected to an encoding head connected to a programming card moved along by the mobile component, the path successively leading the encoding head from one loading station to at least one processing station by simultaneously executing electronic customisation of the component, then either to the output or to a rejection station.

According to a particular feature, the machine comprises a processing unit ensuring control of the different stations of the machine and control of the drive means of the transfer device.

According to another particular feature, the programming card ensures electronic customisation of the component of the portable object even during processing of the portable object by a processing station.

According to another particular feature, the processing station is a checking station and a control considered as defective carried out by the station triggers diversion of the operation program of the machine executed by the processing unit to a incident processing program executed by the processing unit, this program ensuring a special reconstruction cycle of an object whereof the defective condition was detected, the interruption of the electronic programming of the defective component, the control of the transfer device for guiding the portable object from the position in which an error is detected at a scrap rejection position while continuing the programming of the other components, then bringing of the now free encoding head to the loading station to load a portable electronic object to be programmed, and at the same time, reloading of the programming card connected to the encoding head freshly loaded with the data provided initially for the rejected portable object, as well as reloading of data from stations located between the defect-detection position and the input station then resuming of operations at each station with the data corresponding to the object replaced until the position where the defect was detected is reached.

According to another particular feature, the contact means of the encoding head are arranged so as to give free access to all the other zones of the portable object with the exception of the contact zones in the case of a portable contact object, to allow graphic or external customisation operations on the objects during electrical customisation.

According to another particular feature, the memory of the computer system comprises for each object

a unique identifier;

information relative to the initial data (for example, name of the data file, position of this object in the data file . . . );

variable data serving as customisation (for example, full names, expiration date, photo, barcode . . . );

the status of the object (valid object, defective object) and type of error (for example, error during programming of the chip, of the laser, following a mechanical defect).

According to another particular feature, the machine management software administers the normal cycle of the machine and a special reconstruction cycle of an object.

According to another particular feature, the software associates in current status memory of the computer system (8) the list of objects at their physical positions in the machine.

According to another particular feature, during a special reconstruction cycle of an object, the status of the machine, the identifiers and the statuses of the objects are saved in a specific default memory to reposition the machine in the same status as prior to the start of the reconstruction cycle, the procedure of the software being run during the reconstruction cycle comprises:

saving of the machine status in a dedicated default memory;

rotation of the transfer to bring the object detected as defective opposite the rejection station, the electrical customisation operations of the other objects continuing and the operations provided on the other stations of the machine for these other objects being stopped;

the Ejection order of the defective object;

the displacement order of the transfer (4) to bring the free station in front of the loading station and loading a new object;

the resumption of a complete cycle to have all the operations of the encoding head connected to the object redone, having replaced the defective object;

at each step saving the status of the machine in the status memory;

stopping the special reconstruction cycle once the current status of the machine corresponds to the machine status saved in dedicated memory prior to the start of the reconstruction cycle, by comparison of the information recorded in the dedicated memory with the working memory storing the statuses of the machine at each step;

continuing the process via a normal cycle by transferring the objects to the following stations and by resuming the operations where they had been discontinued by loading in the control cards of each station the information associated with the object present in the station according to the information of the status memory of the machine.

Other particular features and advantages will emerge more clearly from the description made in reference to the attached diagrams illustrating an illustrative embodiment of the invention, in which:

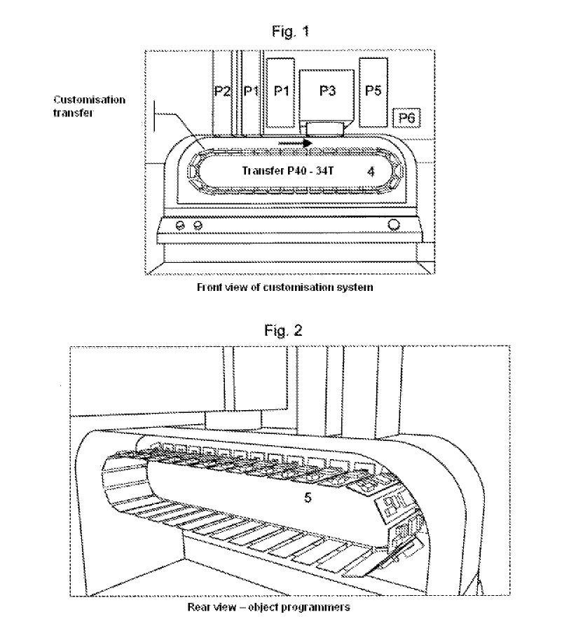

FIG. 1 illustrates a front view of the customisation system according to the invention;

FIG. 2 illustrates a rear view of the customisation system according to the invention;

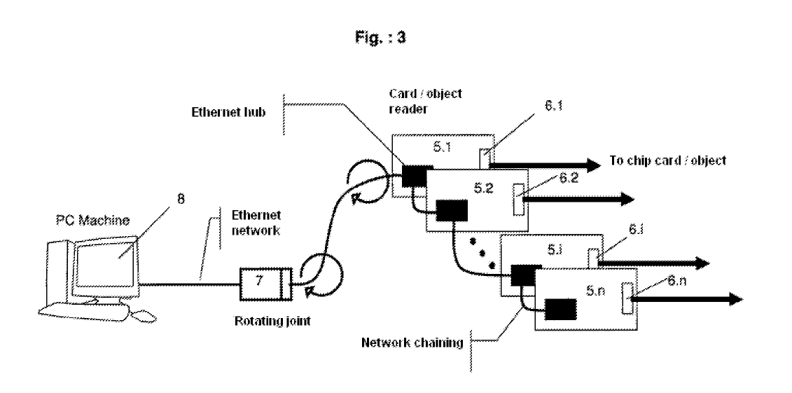

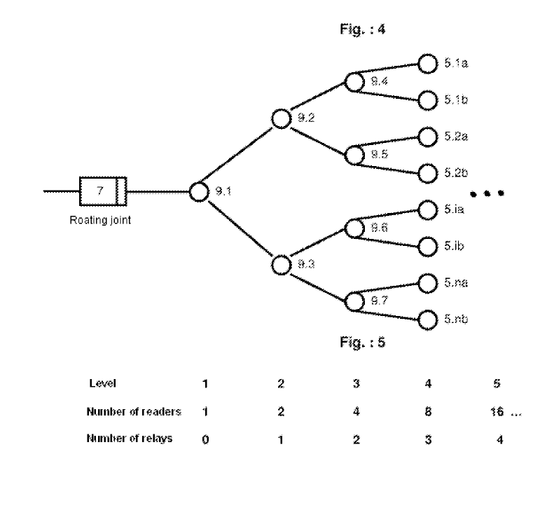

FIG. 3 illustrates the electric programming means of the portable objects and especially an example of series network chaining of the programming cards connected to the encoding heads;

FIG. 4 illustrates another cabling example of the network in a tree structure of the programming cards for each of the encoding heads;

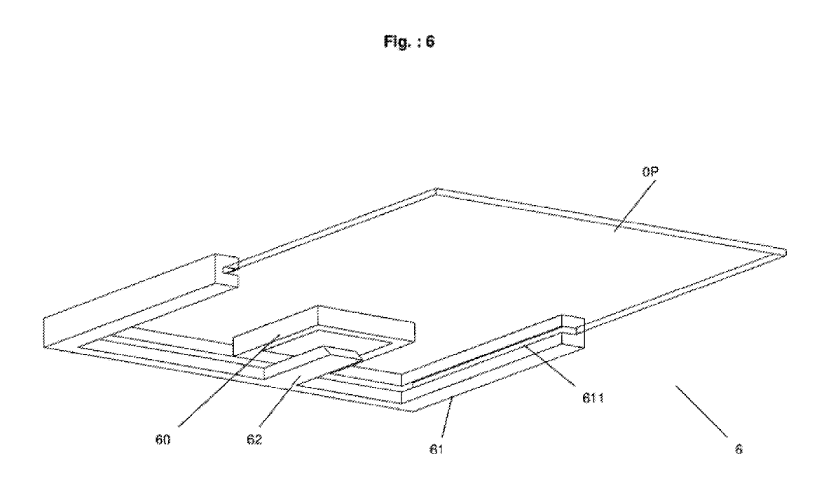

FIG. 5 illustrates the table representing the number of relays to be connected according to the number of programming cards;

FIG. 6 illustrates a perspective view of an embodiment of an encoding head in the case of a portable contact object;

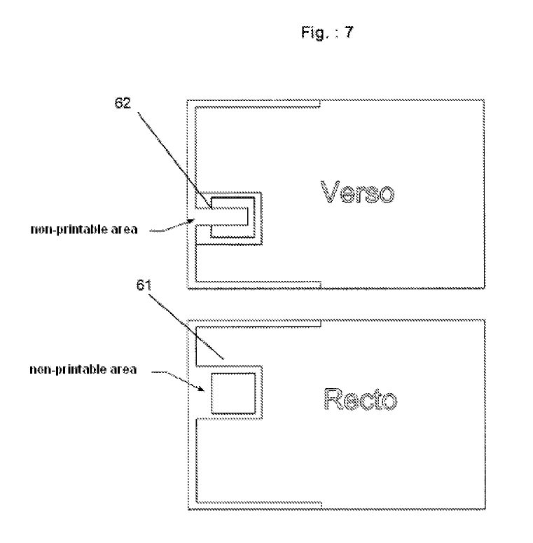

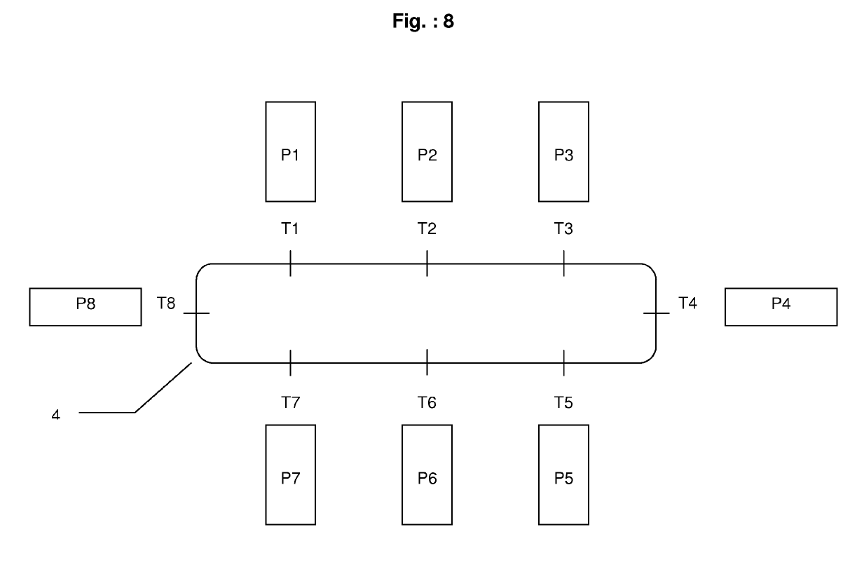

FIG. 7 schematically illustrates a top plan view and a bottom plan view of the zones of the portable object available for other operations during the electrical programming of the electronic circuit of the portable object;

FIG. 8 schematically illustrates an example of a configuration of a machine of type containing 8 encoding heads and 4 parallel processing stations.

### DESCRIPTION OF THE INVENTION

The present invention describes architecture mechanical of electrical and graphic customisation machine of portable electronic objects. This machine has the particular characteristic of combining the function of electrical programming of objects during transport and execution, at each station of the machine, of other operations on the objects, such as for example functions of control, graphic customisation, etc., at the same time as electrical customisation of the electronic circuit of the object continues. The electrical customisation transfer (4) is the core of the machine.

Its primary function consists of transporting the electronic objects from station to station so that each object follows the preferred production process (for example) a laser marking or inkjet station (P3), a camera inspection station (P4), a label-application station (P5), a scrap-rejection station (P6), an unloading station (P2), etc.). This transfer function is found in all existing assemblies of machines for customisation, laser etching, label application, etc.

5

The transfer device (4) comprises a plurality of mobile components arranged so as to move according to a closed-loop path, each mobile component being moved along according to the path and connected to an encoding head (6).

10

The second role of customisation transfer (4) of the invention consists of programming the electronic objects (OP) during their displacement by means of the encoding head (6) connected to the programmer (5). So as soon as an object is extracted from the input loading station (P1) then inserted in the transfer (4) at a position i, the link with the programming card (5i) ensuring the programming function of the electronic circuit of the object (OP) is ensured and the programming of the component can commence immediately. As it moves on to the different processing stations (P3, P4, P5) the object (OP) continues to be programmed in parallel until it is extracted at the output unloading station (P2) or is ejected at the reject bin of the station (P6).

To ensure that programming of objects continues during their displacement, each electrical encoding head (6) is coupled to a programmer (5). The programmers (5) are connected to each moving encoding head and are shifted at the same time as the latter.

The electrical connection between the moving programmers (5) and a system for managing and distributing the data (8) (a PC for example), is ensured by a rotating collector or rotating joint (7).

Any other device for transfer of data and feeding to the programmers (5) can be utilised, such as for example a wireless link or a wired link enabling limited displacement in an alternative direction.

Advantages of the system:

Such architecture combines two functions into one (the transport function and the electrical programming function). This reduces footprint and costs. Concurrent systems have a transfer system for conveying the objects from station to station. One of the stations of a machine consists of a system for accumulation of objects in view of their programming. This additional station therefore does not exist in the present invention as the latter is managed by the transport.

Since the programming time of objects can last several minutes, the architecture of the invention gives maximum times to programming (from its entry to the machine to its output). The objects also benefit from the return time in the lower part as compared to existing machines which insert the objects on one side of the machine and have them exit from the other side.

For some applications for customisation of objects or chip cards, it is required at the machine output that the order of the objects is respected and closely follows the order of data files.

During production of the objects, several types of defects can occur requiring automatic rejection of the defective object. This can be an electric defect during programming of the object or a graphic defect, occurring during marking on the object. Visual control defects can exist, as can mechanical defects associated with the machine in question.

For those machines known from the prior art, such defective objects rejected automatically create a gap in the sequence as the system is physically incapable of remaking the object and reinserting it at the machine output in the appropriate place.

As a result, it is necessary to reproduce the defective object or objects of ongoing production. An operator will then be responsible for interleaving the produced objects into the overall batch. Such an operation is costly in terms of time, machine downtime for occasionally remaking a single object, and is a source of error during manual insertion in the sequence.

If an object is seen as defective by the machine (programming error), it is possible to have the programming transfer shifted to bring the encoding head (6i) of the object in question opposite the scrap rejection station (P6). The object is then ejected. The transfer then moves to present the free encoding head in front of the loading station (P1) so that a fresh object can be inserted. The programming picks up on this object with the data of the object previously ejected. The transfer again continues its displacement to assume its initial position and the cycle continues. The continuity in sequence of the output objects is then respected and there is no gap in the programming sequence.

In the same way, if an object is judged defective during its graphic marking (either because the marking station (P3) signals an error, or because an optical inspection system (P4) declares the marking incorrect), the replacement sequence is carried out to remake this object automatically. The output sequence is still respected. This functionality is not possible on current commercial machines.

Once the object is inserted in the customisation transfer, the object is no longer handled (except for possible referencing for some stations such as laser marking). This particular feature uses this machine for small-sized objects which are difficult to handle. This also varies the external forms of the object without as such having to mechanically reconfigure the whole machine. For example, if the connection between the transfer (4) and the object is made via a standard USB connector, the machine could easily accept different forms of USB drives irrespective of their external forms and without major adaptation of the machine.

To retain the output order of the machine, it is important to have the means to dynamically remake the defective object irrespective of its type of defect and to reinsert at the appropriate place.

The proposed customisation transfer instinctively remakes all the objects detected as substandard, irrespective of their place inside the machine and repositions them in their place.

The automatic reconstruction rationale is described hereinbelow:

The object contained in the customisation head X of the rotating transfer is detected as being substandard (electrical/graphic/other defect)

The machine stores the current mechanical position of the customisation head associated with the defective portable object (position A)

The machine rotates the transfer so as to present the head X opposite the ejection station (P6) for defective objects

The object is ejected. The head X is now empty.

The machine rotates the transfer to position the head X opposite the input station (P1) for blank objects (the unstacker)

A fresh blank object is then inserted in the empty position

The control software reallocates the former data of the rejected object on the programmer (5.x) associated with the fresh blank object.

The electrical programming of the object commences with the former data.

During electrical programming, the transfer rotates to present the head X to the first graphic customisation station (for example with marking laser). The information associated with the object is then printed, while the information to be programmed in the electronic memory of the portable object is written. To this effect and as illustrated in FIG. 6, the encoding head comprises a contact pad (60) positioned opposite the contacts of the portable object and a tab 62 pressing the portable object (OP) against the contact pad (60). These two elements are solid with a support element (61) linked mechanically to the mobile transfer (4). Each support element (61) in a U-shape comprises a throat (611) in which a portable object (OP) is slid. As is evident from FIG. 7 the linking elements between the portable object (OP) and the programmer (5) cover over a minimum of external surface of the portable object to allow parallel processing at other stations (laser etching or embossing, etc., while electrical customisation continues).

And so on to have the blank object again pass by all the processing stations until the machine is in position A (current position before deviation of the machine cycle to manage the remaking procedure) and until the object is in the same position and in the same status (the defect less) as previously.

At this stage, the defective object has been remade, inserted in the proper position and the cycle resumes for all objects present in the transfer, as if no defect had been noticed.

To manage the automatic remaking procedure of defective cards or objects during their customisation on the machine, the management software of the computer means (8) of the machine should at all times have information representing the status of the portable objects (status) as well as the history of operations carried out.

Each object, as soon as it is inserted in the machine via the input position, is linked to a memory space of the computer management system of the machine containing all the information necessary for its follow-up:

Unique identifier;

Information relative to the initial data (for example, name of the data file, position of this object in the data file . . . );

Variable data serving as customisation (for example, full names, expiration date, photo, barcode . . . ). These data can be used for example to program the chip, for inkjet or laser printing, for programming of the magnetic strip, etc. . . . ;

Status of the object (valid object, defective object) and type of error (for example, error during programming of the chip, of the laser, following a mechanical defect . . . )

Each reader is embedded on the customisation transfer. Corresponding to each encoding head (6i) (or each object) is a reader (5i) physically embedded on the customisation head (the sled supporting the head, the connection, the reader, the object and the holding means . . . ).

The readers are networked by chaining Ethernet relays (9.1 to 9.7) illustrated in FIGS. 4 and 5 to prevent too large a number of wires from passing through the rotating joint (7) (limited to number of wires).

To reduce the length of the reader chain (and therefore the time taken to interrogate the last reader of the chain), it can be envisaged that each reader has 2 Ethernet outputs (5.1a, 5.1b) for connecting the 2 following readers. FIG. 3 illustrates series chaining of readers. This chaining is the best adapted to physically link the readers with each other, but has the disadvantage of being the slowest. FIG. 4 illustrates a tree structure where each reader constitutes a node connecting the following 2 readers. This principle has greater efficacy but a mechanically less advantageous connection.

The machine management software also has a file describing the configuration of the machine. For each physical and functional station of the machine there is consequently a descriptor describing the type of station and its operating options.

A machine could, for example and according to FIG. 8, comprise a customisation transfer (4) comprising 8 encoding heads with 4 processing stations implanted around them:
Station 1: Stacker (output tray)
Station 2: Unstacker (input tray)
Station 3: Laser printing
Station 4: Reject tray
Station 5: Free
Station 6: Free
Station 7: Free
Station 8: Free

To manage the list of objects present in the machine, the software associates in current status memory of the computer system (8) the list of objects and their physical positions in the customisation transfer. The following is in memory:
T1: Empty (the object was previously stacked in the output charger)
T2: Object No. 00011
T3: Object No. 00010
T4: Object No. 00009
T5: Object No. 00008
T6: Object No. 00007
T7: Object No. 00006
T8: Object No. 00005

The software then connects the position of the encoding heads Ti relative to the processing stations. The following is in memory, for example:
Station 1: T1: Empty
Station 2: T2: Object No. 00011
Station 3: T3: Object No. 00010
Station 4: T4: Object No. 00009
Station 5: T5: Object No. 00008
Station 6: T6: Object No. 00007
Station 7: T7: Object No. 00006
Station 8: T8: Object No. 00005

This real status of the machine is saved and updated as a function of the machine cycle:

When the machine stops, the computer system saves the positions and the identifiers of the objects.

When the machine starts back up, the computer system reloads the positions and objects so as to continue the cycle as if the machine had never stopped.

At each advance of the customisation transfer, the current status memory is modified by having the list of objects advance by one step:
Station 1: T8: Empty (the object No. 0005 was stacked at output)
Station 2: T1: Object No. 00012 (fresh object entering)
Station 3: T2: Object No. 00011
Station 4: T3: Object No. 00010
Station 5: T4: Object No. 00009
Station 6: T5: Object No. 00008
Station 7: T6: Object No. 00007
Station 8: T7: Object No. 00006

During a special reconstruction cycle of an object, it is necessary to save the status of the machine, the identifiers and the statuses of the objects in a specific default memory to then reposition the machine in the same status as prior to the start of the reconstruction cycle. The procedure can be viewed as follows:
The object No. 00011 is detected as substandard at Station 3 (laser);
Saving of the machine status in a dedicated default “memory”;
Station 1: T8: Empty
Station 2: T1: Object No. 00012
Station 3: T2: Object No. 00011 (defect)
Station 4: T3: Object No. 00010
Station 5: T4: Object No. 00009
Station 6: T5: Object No. 00008
Station 7: T6: Object No. 00007
Station 8: T7: Object No. 00006
Rotation of the transfer to bring the object 00011 opposite the rejection station P4 (in this example the transfer advances by one step), the electrical customisation operations of the other objects continue and the operations provided on the other stations of the machine being stopped;
Saving of the real status of the machine represented hereinbelow:
Station 1: T7: Object No. 00006
Station 2: T8: Empty
Station 3: T1: Object No. 00012
Station 4: T2: Object No. 00011 (defect)
Station 5: T3: Object No. 00010
Station 6: T4: Object No. 00009
Station 7: T5: Object No. 00008
Station 8: T6: Object No. 00007
Ejection command of the object; The head T2 is located opposite P4 is now empty
Saving the machine status
Rotation of the transfer (4) to bring the free station in front of the unstacker P2 and insertion of a fresh blank object;
Station 1: T1: Object No. 00012
Station 2: T2: Empty (a fresh blank object recovering the data No. 00011 is inserted)
Station 3: T3: Object No. 00010
Station 4: T4: Object No. 00009
Station 5: T5: Object No. 00008
Station 6: T6: Object No. 00007
Station 7: T7: Object No. 00006
Station 8: T8: Empty
From there, the computer control system of the machine resumes the full cycle to have all the operations remade at the encoding head T2 connected to the object (00011), having replaced the defective object.

In our example, the blank object No. 00011 goes past the laser P3 again to graphically inscribe the data;
At each step, the status of the machine is saved;
The special reconstruction cycle stops once the status of the machine corresponds to the machine status saved prior to the start of the reconstruction cycle:
Station 1: T8: Empty
Station 2: T1: Object No. 00012
Station 3: T2: Object No. 00011
Station 4: T3: Object No. 00010
Station 5: T4: Object No. 00009
Station 6: T5: Object No. 00008
Station 7: T6: Object No. 00007
Station 8: T7: Object No. 00006
At this moment, the machine is in the same configuration and in the same position, except that the defective object is now replaced by a completely remade and valid object.
The process then resumes its cycle normally by transferring the objects to the following stations
and this continues until detection of another defect on an object or when the machine stops normally.

It must be evident for experts that the present invention enables embodiments in numerous other specific forms without departing from the field of application of the invention as claimed. Consequently, the present embodiments must be considered by way of illustration but can be modified in the field defined by the reach of the attached claims.

1. A machine for electrical and graphic customisation of portable electronic objects comprising a loading station, a plurality of processing stations, including at least one laser jet or inkjet marking station and/or an inspection station and/or a label-application station, a rejection station and an unloading station of customised objects, wherein a transfer device comprises at least one mobile component, according to a closed-loop path, each mobile component being moved along, according to the path and connected to an encoding head connected to a programming card moved along by the mobile component, the path successively leading the encoding head from one loading station to at least one of the processing stations of the plurality of processing stations by simultaneously executing electronic customisation of the component then, either to an output station or to a rejection station.

2. The machine as claimed in claim 1, further comprising a processing unit ensuring control of the different stations of the machine and control of the drive means of the transfer device.

3. The machine as claimed in claim 1, wherein the programming card ensures electronic customisation of the component of the portable object even when the portable object passes in front of one of the processing stations.

4. The machine as claimed in claim 1, wherein the processing station is a checking station and a control considered as defective carried out by the station is arranged to trigger diversion of the operation program of the machine used by the processing unit to an incident processing program executed by the processing unit, the program ensuring the detection of the defective condition of an operation, the interruption of the electronic programming of the component, the order of the transfer device to bring the portable object of the position in which an error is detected to a scrap rejection position while continuing the programming of other components, then bringing the now free encoding head to the loading station to load a portable electronic object to be programmed, and at the same time, reloading of the programming card connected to the encoding head freshly loaded with the data provided initially for the rejected portable object, as well as reloading of the data from stations located between the defect-detection position and the input station, then resumption of operations at each station with the data corresponding to the object replaced until the position where the defect was detected is reached.

5. The machine as claimed in claim 1, wherein the contact means of the encoding head are placed so as to give free access to all the other zones of the portable object with the exception of the contact zones in the case of a portable contact object, to allow graphic operations or external customisation on the objects during electrical customisation.

6. The machine as claimed in claim 1, wherein the memory of the computer system comprises for each object:
a unique identifier;
information relative to the initial data;
variable data serving as customisation;
the status of the object.

7. The machine as claimed in claim 1, wherein the machine management software is arranged to administer the normal cycle of the machine and a special reconstruction cycle of an object.

8. The machine as claimed in claim 1, wherein the software is arranged to associate in current status memory of the computer system the list of objects at their physical positions in the machine.

9. The machine as claimed in claim 1, wherein, during a special reconstruction cycle of an object, the status of the machine, the identifiers and the statuses of the objects are saved in a specific default memory to reposition the machine in the same status as prior to the start of the reconstruction cycle, the procedure of the software being configured to run during the reconstruction cycle comprises:
rotation of the transfer to bring the defective object opposite the rejection station and ejection of the defective object, with the electrical customisation operations of other objects continuing and the operations provided on the other stations of the machine being stopped;
the ejection order of the object;
the displacement order of the transfer to bring the free station in front of the unstacker and loading a new object;
saving the machine status in a dedicated default memory;
the resumption of a complete cycle to have all operations redone at the encoding head associated with the fresh object having replaced the defective object;
at each step saving of the status of the machine in the status memory;
stopping the special reconstruction cycle once the status of the machine corresponds for the other objects to the machine status saved en dedicated memory prior to the start of the reconstruction cycle, by comparison of the information recorded in the dedicated memory with the working memory storing the statuses of the machine at each step; and
continuing the process via a normal cycle by transferring the objects to the following stations and by resuming the operations where they had been discontinued by loading in the control cards of each station the information associated with the object present in the station according to the information of the status memory of the machine.
